(19) United States
(12) Patent Application Publication
(10) Pub. No.: US 2025/0252900 A1
(43) Pub. Date: Aug. 7, 2025

(54) DRIVING CONTROLLER AND DISPLAY APPARATUS INCLUDING THE SAME

(71) Applicant: Samsung Display Co., Ltd., Yongin-Si (KR)

(72) Inventors: BYUNGSUN KIM, Yongin-si (KR); NAM-GON CHOI, Yongin-si (KR); Yoosung Kim, Yongin-si (KR); Yongjae Lee, Yongin-si (KR); BYUNGKIL JEON, Yongin-si (KR)

(21) Appl. No.: 18/954,531

(22) Filed: Nov. 21, 2024

(30) Foreign Application Priority Data
Feb. 5, 2024 (KR) 10-2024-0017293

(51) Int. Cl. G09G 3/32; G09G 3/3266; G09G 3/3291

(52) U.S. Cl. CPC G09G 3/32; G09G 3/3266; G09G 3/3291; G09G 2310/0267; G09G 2310/0275; G09G 2330/10

(57) ABSTRACT

A display apparatus comprises a display panel including a first repair pixel block, a second repair pixel block and a plurality of pixels, a gate driver configured to output a gate signal to the display panel, a data driver configured to apply a data voltage based on a data signal to the display panel, and a driving controller configured to control the gate driver and the data driver and output the data signal based on input image data. Either the first repair pixel block or the second repair pixel block may apply a repair driving current to at least one pixel among the plurality of pixels based on the data signal and a location of the at least one pixel.

### CROSS-REFERENCE TO RELATED APPLICATION(S)

This application claims priority under 35 USC § 119 to Korean Patent Application No. 10-2024-0017293, filed on Feb. 5, 2024, in the Korean Intellectual Property Office (KIPO), the content of which is incorporated herein by reference in its entirety.

### BACKGROUND

### 1. Field

Embodiments of the present disclosure relate to a display apparatus with improved yield.

### 2. Description of the Related Art

Generally, a display apparatus includes a display panel and a panel driver. The display panel includes a plurality of gate lines, a plurality of data lines and a plurality of pixels. The display panel driver includes a gate driver providing a gate signal to the gate lines, a data driver providing a data voltage to the data lines and a driving controller controlling the gate driver and the data driver.

Generally, a defective pixel may occur during a manufacturing process. When the defective pixel occurs, the yield of the display apparatus may decrease.

### SUMMARY

Embodiments of the present disclosure provide a display apparatus with improved yield by harnessing a repair pixel to drive a defective pixel.

According to an embodiment, a display apparatus comprises a display panel including a first repair pixel block, a second repair pixel block and a plurality of pixels, a gate driver configured to output a gate signal to the display panel, a data driver configured to apply a data voltage based on a data signal to the display panel, and a driving controller configured to control the gate driver and the data driver and output the data signal based on input image data. Either the first repair pixel block or the second repair pixel block may apply a repair driving current to at least one pixel among the plurality of pixels based on the data signal and a location of the at least one pixel.

The data driver may include a first repair amplifying block applying a first repair data voltage to the first repair pixel block, a second repair amplifying block applying a second repair data voltage to the second repair pixel block, and a data amplifying block applying a pixel data voltage to the pixels.

The first repair pixel block may generate a first repair driving current based on the first repair data voltage. The second repair pixel block may generate a second repair driving current based on the second repair data voltage.

Driving controller may include a location determining block determining the location of the at least one pixel and outputting a location signal, wherein the at least one pixel may receive the repair driving current, a data selecting block outputting a data selecting signal generated by determining a color of the at least one pixel and a repair pixel block connected close to the at least one pixel based on the location signal, an offset calculating block outputting an offset signal based on the data selecting signal, an amplifier compensating data outputting block outputting an amplifier compensating data signal based on the data selecting signal and a delay calculating block outputting a delay data signal based on the offset signal and the amplifier compensating data signal. The data signal may be generated based on the delay data signal.

The location determining block may generate the location signal by determining a pixel-row of the at least one pixel and a pixel-column of the at least one pixel.

The data selecting signal may include a color data selecting signal. The data selecting block may be a signal for outing the repair driving current corresponding to the color of the at least one pixel.

The data selecting signal may include a location data selecting signal. The data selecting block may be a signal for activating one of the first repair pixel block and the second repair pixel block.

The offset calculating block may generate the offset signal based on the data selecting signal and a panel characteristic of the display panel.

The offset signal may be generated by using the data selecting signal and a reference grayscale look-up table based on the panel characteristic.

The data driver may include a first repair amplifying block applying a first repair data voltage to the first repair pixel block and a second repair amplifying block applying a second repair data voltage to the second repair pixel block. The amplifier compensating data outputting block may generate the amplifier compensating data signal based on amplifier characteristic of the first repair amplifying block or the second repair amplifying block.

The delay calculating block may generate the delay data signal based on the offset signal, the amplifier compensating data signal, and a calculation delay occurring during an operation of at least one of the location determining block, the data selecting block, the offset calculating block and the amplifier compensating data outputting block.

The data driver may include a data receiving block, and the driving controller further includes a signal outputting block. The signal outputting block outputs the data signal. The data receiving block may receive the data signal and output a first repair data signal to the first repair pixel block and a second repair data signal to the second repair pixel block.

The first repair pixel block and the second repair pixel block may be connected with each of the plurality of pixels through a repair line.

The first repair pixel block may include a plurality of first repair pixels and the second repair pixel block includes a plurality of second repair pixels. The at least one pixel may include a light emitting element. A repair pixel among the plurality of first repair pixels or the plurality of second repair pixels may be connected with and applies the repair driving current to the light emitting element through the repair line. The light emitting element may emit light based on the repair driving current.

The display panel may include a gate line receiving the gate signal, a data line receiving the data voltage and the repair line. The gate line and the repair line may extend in a first direction, and the data line may extend in a second direction different from the first direction.

The first repair pixel block may be located in a first side of the display panel and the second repair pixel block may be located in a second side of the display panel different from the first side of the display panel.

According to an embodiment, a driving controller comprises a location determining block determining a location of a defective pixel and outputting a location signal indicating the location of the defective pixel, wherein the defective pixel may receive a repair driving current, a data selecting block outputting a data selecting signal generated by determining a repair pixel block connected close to the defective pixel based on the location signal, an offset calculating block outputting an offset signal based on the data selecting signal, an amplifier compensating data outputting block outputting an amplifier compensating data signal based on the data selecting signal, and a delay calculating block outputting a delay data signal based on the offset signal and the amplifier compensating data signal.

The data selecting signal may include a color data selecting signal. The color data selecting signal may be a signal for outputting the repair driving current corresponding to a color of the defective pixel.

The data selecting signal may include a location data selecting signal. The location data selecting signal may be a signal for activating one of the first repair pixel block and the second repair pixel block.

The amplifier compensating data outputting block may generate the amplifier compensating data signal based on amplifier characteristic of the first repair amplifying block or the second repair amplifying block.

As described above, according to the driving controller and the display apparatus including the same, a repair driving current applied to a defective pixel may be generated based on a repair data voltage. The repair data voltage may be generated based on a repair data signal. Additionally, a panel characteristic, an amplifier characteristic and a calculating delay may be considered in the repair data signal. Accordingly, a driving reliability and a driving stability of the repair pixel generating the repair driving current may be improved. Additionally, an emission reliability of the light emitting element included in the defective pixel may be improved.

### BRIEF DESCRIPTION OF THE DRAWINGS

The above and other features of the present disclosure will become more apparent with reference to the descriptions below and the accompanying drawings.

FIG. 1 is a block diagram illustrating a display device according to an embodiment of the present disclosure.

FIG. 2 is a block diagram illustrating a display panel, a driving controller and a data driver of a display apparatus of FIG. 1.

FIG. 3 is a block diagram illustrating a repair pixel block and a pixel of FIG. 2.

FIG. 4 is a block diagram illustrating a data driver of a display apparatus of FIG. 1.

FIG. 5 is a block diagram illustrating a driving controller of a display apparatus of FIG. 1.

FIG. 6 is a block diagram illustrating a driving controller included in a display apparatus of FIG. 1.

FIG. 7 is a block diagram illustrating a data driver included in a display apparatus of FIG. 1.

FIG. 8 is a block diagram illustrating an electronic device according to an embodiment of the present disclosure.

FIG. 9 is a diagram illustrating an example in which an electronic device of FIG. 8 is implemented as a smart phone.

### DETAILED DESCRIPTION OF THE EMBODIMENTS

Hereinafter, embodiments according to the present inventive concept will be explained in detail with reference to the accompanying drawings. The same reference numerals are used for the same components in the drawings, and redundant descriptions of the same components will be omitted.

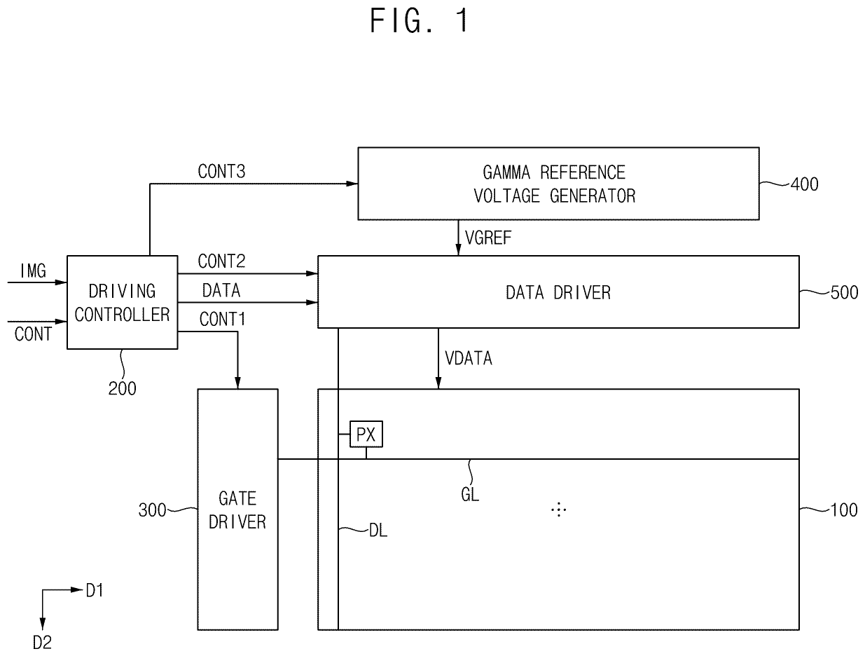

FIG. 1 is a block diagram illustrating a display device according to an embodiment of the present disclosure.

Referring to FIG. 1, the display device may include a display panel 100 and a panel driver. The panel driver may include a driving controller 200, a gate driver 300, a gamma reference voltage generator 400 and a data driver 500.

The display panel 100 may have a display region on which an image is displayed and a peripheral region adjacent to the display region.

The display panel 100 may include a plurality of gate lines GL, a plurality of data lines DL and a plurality of pixels PX connected to the gate lines GL and the data lines DL. The gate lines GL may extend in a first direction D1. The data line DL may extend in a second direction D2 crossing the first direction D1.

The driving controller 200 may receive input image data IMG and an input control signal CONT from an external device. For example, the input image data IMG may include red image data, green image data and blue image data. For example, the input image data IMG may include white image data. For example, the input image data IMG may include magenta image data, yellow image data and cyan image data. The input control signal CONT may include a master clock signal and a data enable signal. The input control signal CONT may further include a vertical synchronizing signal and a horizontal synchronizing signal.

The driving controller 200 may generate a first control signal CONT1, a second control signal CONT2, a third control signal CONT3 and a data signal DATA based on the input image data IMG and the input control signal CONT.

The driving controller 200 may generate the first control signal CONT1 for controlling an operation of the gate driver 300 based on the input control signal CONT and output the first control signal CONT1 to the gate driver 300. The first control signal CONT1 may include a vertical start signal and a scan clock signal.

The driving controller 200 may generate the second control signal CONT2 for controlling an operation of the data driver 500 based on the input control signal CONT and output the second control signal CONT2 to the data driver 500. The second control signal CONT2 may include a horizontal start signal and a load signal.

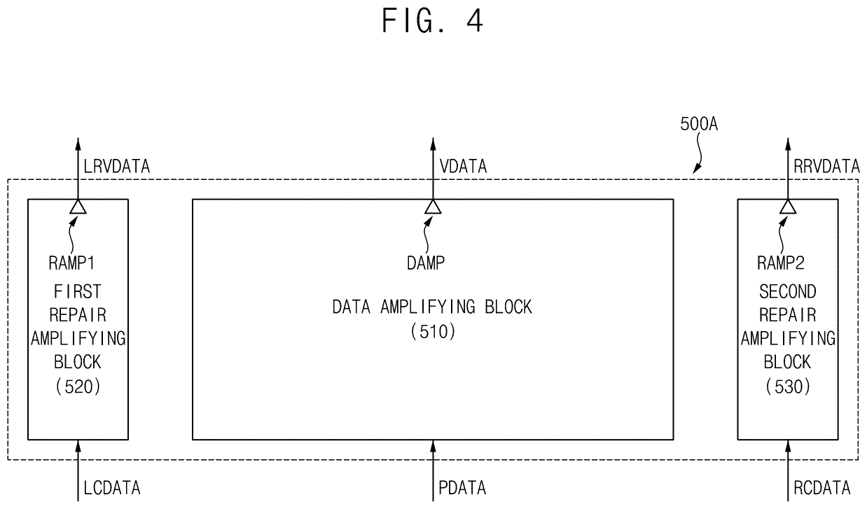

The driving controller 200 may generate the data signal DATA based on the input image data IMG and the input control signal CONT. The driving controller 200 may output the data signal DATA to the data driver 500. The data signal DATA may include a first repair data signal LCDATA, a second repair data signal RCDATA and a pixel data signal PDATA (see also FIG. 4).

The driving controller 200 may generate the third control signal CONT3 for controlling an operation of the gamma reference voltage generator 400 based on the input control signal CONT and output the third control signal CONT3 to the gamma reference voltage generator 400.

The gate driver 300 may generate a gate signal for driving a pixel PX based on the first control signal CONT1 received from the driving controller 200. The gate driver 300 may output the gate signal to the gate lines GL connected to the pixel PX.

In an embodiment of the present disclosure, the gate driver 300 may be integrated on the peripheral region of the display panel 100. In an embodiment of the present disclosure, the gate driver 300 may be mounted on the peripheral region of the display panel 100.

The gamma reference voltage generator 400 may generate a gamma reference voltage VGREF based on the third control signal CONT3 received from the driving controller 200. The gamma reference voltage generator 400 may provide the gamma reference voltage VGREF to the data driver 500. The gamma reference voltage VGREF has a value corresponding to each of the data signal DATA.

For example, the gamma reference voltage generator 400 may be disposed in the driving controller 200 or in the data driver 500.

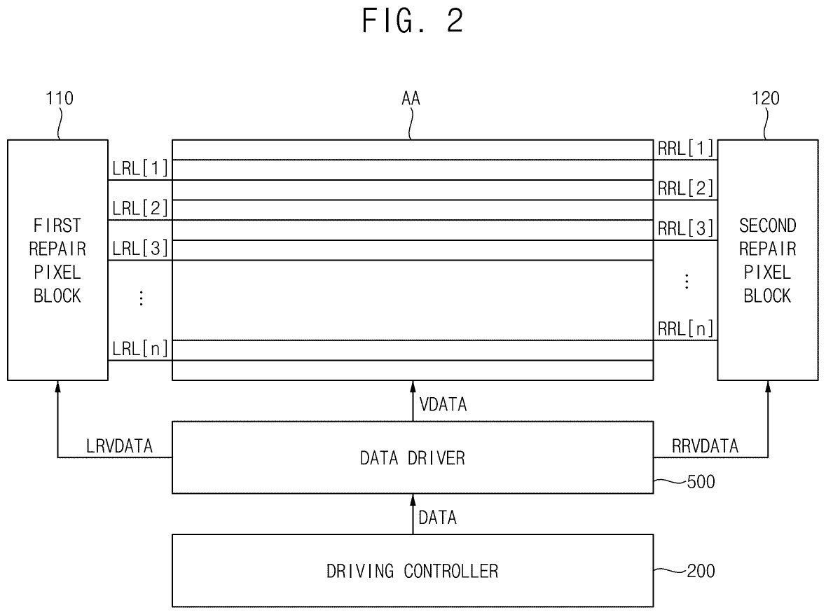

The data driver 500 may receive the second control signal CONT2 and the data signal DATA from the driving controller 200, and receive the gamma reference voltages VGREF from the gamma reference voltage generator 400. The data driver 500 may convert the data signal DATA into an analog form of data voltage using the gamma reference voltages VGREF. The data driver 500 may output the data voltage to the data lines DL. In an embodiment, the data voltage may include a first repair data voltage LRVDATA, a second repair data voltage RRVDATA and a pixel data voltage VDATA (see also FIG. 2).

In an embodiment of the present disclosure, the data driver 500 may be integrated on the peripheral region of the display panel 100. In an embodiment of the present disclosure, the data driver 500 may be mounted on the peripheral region of the display panel 100.

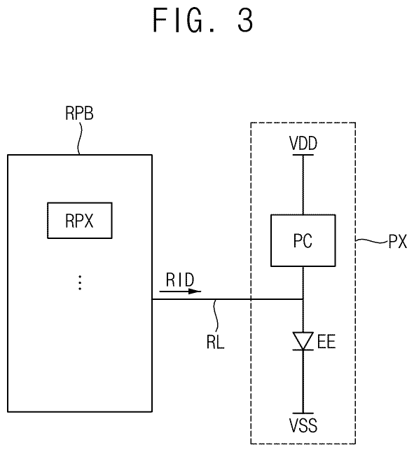

FIG. 2 is a block diagram illustrating a display panel 100, a driving controller 200 and a data driver 500 of a display apparatus of FIG. 1. FIG. 3 is a block diagram illustrating a repair pixel block RPB and a pixel PX of FIG. 2.

Referring to FIG. 1 to FIG. 3, the display panel 100 may include a repair pixel block RPB, a display region AA and a plurality of repair lines RL. The repair lines RL may include a first repair lines LRL[1], LRL[2], LRL[3], . . . and LRL[N] and a second repair lines RRL[1], RRL[2], RRL[3], . . . and RRL[N], where N is a positive integer. The repair pixel block RPB may include a plurality of repair pixel RPX. The repair pixel block may include a first repair pixel block 110 and a second repair pixel block 120. In an embodiment, the first repair lines LRL[1], LRL[2], LRL[3], . . . and LRL[N] and the second repair lines RRL[1], RRL[2], RRL[3], . . . and RRL[N] may extend in the first direction D1.

The pixel PX may be disposed in the display panel 100. In an embodiment, the pixel PX may include a pixel circuit PC and a light emitting element EE. The pixel PX may receive a first power voltage VDD. The pixel PX may be connected to a second power voltage line which provides a second power voltage VSS lower than the first power voltage VDD. The pixel circuit PC may generate a driving current based on the pixel data voltage VDATA. The light emitting element EE may emit light based on the driving current. In an embodiment, the light emitting element EE may include an organic light emitting diode (OLED), a nano light emitting diode (NED), a quantum dot (QD) light emitting diode, a micro light emitting diode, an inorganic light emitting diode, or any other suitable light emitting element.

During a manufacturing process of the display apparatus, a defect may occur in some pixels of the pixels PX. For example, some of the pixels PX may experience defects such as a luminance degradation or incorrect grayscale output. A pixel having the defects may be called a defective pixel.

In an embodiment, the repair pixel RPX included in the repair pixel block RPB may generate a repair driving current RID. For example, the repair pixel RPX may generate the repair driving current RID based on at least one of the first repair data voltage LRVDATA and the second repair data voltage RRVDATA. At least one pixel having defects (e.g., the defective pixel) among the pixels PX may receive the repair driving current RID. For example, the defective pixel may receive the repair driving current RID through the repair line RL. For example, the light emitting element EE included in the defective pixel may be connected to the repair line RL. Accordingly, the light emitting element EE of the defective pixel may emit light based on the repair driving current RID. In an embodiment, the pixel circuit PC of the defective pixel may not be connected to the light emitting element EE, but the light emitting element EE in the defective pixel may be connected to the repair line RL. Accordingly, the light emitting element EE of the defective pixel may emit light based on the repair driving current RID.

The first repair pixel block 110 may include the repair pixels RPX. For example, the first repair pixel block 110 may include first repair pixels. For example, the first repair pixels may output a first repair driving current based on the first repair data voltage LRVDATA. The at least one pixel (e.g., the defective pixel) among the pixels PX may receive the first repair driving current. For example, the defective pixel may receive the first repair driving current through one repair line of the first repair lines LRL[1], LRL[2], LRL[3], . . . and LRL[N]. For example, the light emitting element EE included in the defective pixel may be connected to the one repair line. Accordingly, the light emitting element EE of the defective pixel may emit light based on the first repair driving current. In an embodiment, the pixel circuit PC of the defective pixel may not be connected with the light emitting element EE. Accordingly, the light emitting element EE of the defective pixel may emit light based on the first repair driving current.

The second repair pixel block 120 may include the repair pixels RPX. For example, the second repair pixel block 120 may include second repair pixels. For example, the second repair pixels may output a second repair driving current based on the second repair data voltage RRVDATA. At least one pixel (e.g., the defective pixel) among the pixels PX may receive the second repair driving current. For example, the defective pixel may receive the second repair driving current through one repair line of the second repair lines RRL[1], RRL[2], RRL[3], . . . and RRL[N]. For example, the light emitting element EE included in the defective pixel may be connected to the one repair line. Accordingly, the light emitting element EE of the defective pixel may emit light based on the second repair driving current. In an embodiment, the pixel circuit PC of the defective pixel may not be connected with the light emitting element EE. Accordingly, the light emitting element EE of the defective pixel may emit light based on the second repair driving current.

In an embodiment, the pixels PX may be arranged in the display region AA of the display panel 100. The first repair pixel block 110 may be disposed in a first side of the display panel 100. The second repair pixel block 120 may be disposed in a second side of the display panel 100 different from the first side of the display panel 100.

The first repair pixel block 110 may be connected to defective pixels located close to the first side. The second repair pixel block 120 may be connected to defective pixels located close to the second side.

In an embodiment, the display apparatus may include the first repair pixel block 110 and the second repair pixel block 120. Accordingly, when the defects occur in some of the pixels, through the first repair pixel block 110 and the second repair pixel block 120, the defective pixels having the defects may be driven. Accordingly, the yield of the display apparatus may be improved.

Additionally, the first repair pixel block 110 may be located in the first side and the second repair pixel block 120 may be located in the second side. The defective pixel located close to the first side may be driven by the first repair pixel block 110. The defective pixel located close to the second side may be driven by the second repair pixel block 120. Accordingly, a driving reliability and a driving stability of the defective pixels may be improved. For example, an impact caused by a distance between the defective pixels and the repair pixel block RPB may be reduced. Accordingly, an emission reliability of the light emitting element of the defective pixel may be further improved.

FIG. 4 is a block diagram illustrating a data driver 500 of a display apparatus of FIG. 1.

Referring to FIG. 1 to FIG. 4, the data driver 500A may include a data amplifying block 510, a first repair amplifying block 520 and a second repair amplifying block 530.

The data amplifying block 510 may include a plurality of data amplifiers DAMP connected to the data lines DL. The data amplifying block 510 may output the pixel data voltage VDATA which is generated based on the pixel data signal PDATA.

The first repair amplifying block 520 may output the first repair data voltage LRVDATA which is generated based on the first repair data signal LCDATA. In an embodiment, the first repair amplifying block 520 may include a plurality of first repair amplifiers RAMP1. The first repair amplifiers RAMP1 may output the first repair data voltage LRVDATA, which is generated based on the first repair data signal LCDATA, to the first repair pixels. The number of the first repair amplifiers RAMP1 included in the first repair amplifying block 520 is not limited to those depicted in FIG. 4. For example, the first repair amplifying block 520 may include one first repair amplifier or include a plurality of first repair amplifiers.

The second repair amplifying block 530 may output the second repair data voltage RRVDATA which is generated based on the second repair data signal RCDATA. In an embodiment, the second repair amplifying block 530 may include a plurality of second repair amplifiers RAMP2. The second repair amplifiers RAMP2 may output the second repair data voltage RRVDATA, which is generated based on the second repair data signal RCDATA, to the second repair pixels. The number of the second repair amplifiers RAMP2 included in the second repair amplifying block 530 is not limited to those depicted in FIG. 4. For example, the second repair amplifying block 530 may include one second repair amplifier or a plurality of second repair amplifiers.

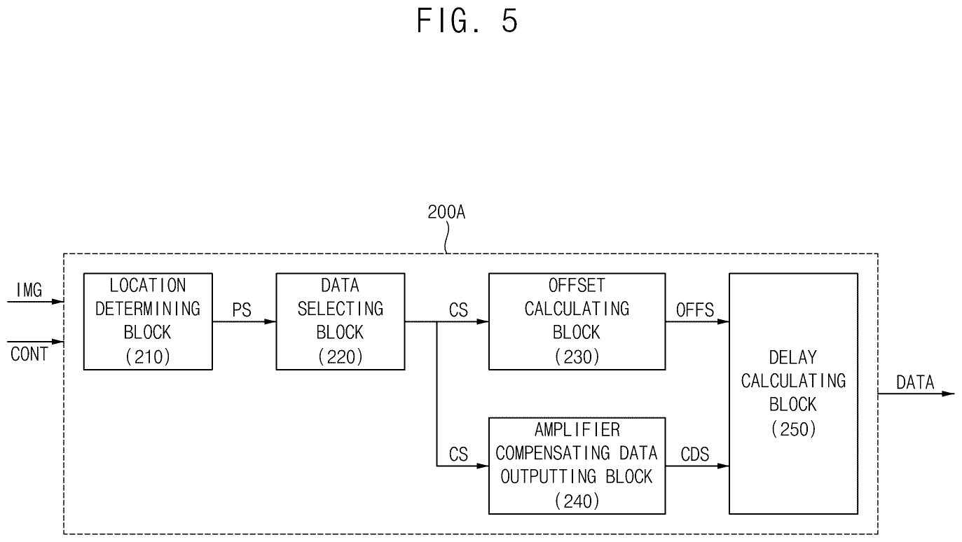

FIG. 5 is a block diagram illustrating a driving controller 200 of a display apparatus of FIG. 1.

Referring to FIG. 1 to FIG. 5, the driving controller 200A may include a location determining block 210, a data selecting block 220, an offset calculating block 230, an amplifier compensating data outputting block 240 and a delay calculating block 250.

The location determining block 210 may determine a location of the pixels PX and output a location signal PS. For example, the location determining block 210 may determine a location of the defective pixel and output the location signal PS including an information of the location of the defective pixel.

In an embodiment, the location determining block 210 may include a first location register and a second location register. The first location register may store an information about a pixel-column of the pixels PX. For example, the first location register may be about 12-bits register. When the first location register is about 12-bits register, the first location register may store an information of first to 4096-th pixel-columns. However, the present disclosure is not limited to the number of bits of the first location register. The second location register may store an information about a pixel-row of the pixels PX. For example, the second location register may be about 12-bits register. When the second location register is about 12-bits register, the second location register may store an information of first to 4096-th pixel-rows. However, the present disclosure is not limited to the number of bits of the second location register.

The data selecting block 220 may output a data selecting signal CS based on the location signal PS. The data selecting signal CS may include a color data selecting signal and a location data selecting signal.

The data selecting block 220 may determine a color of the defective pixel and generate the color data selecting signal for outputting the repair driving current RID corresponding to the color of the defective pixel. For example, when the defective pixel includes the light emitting element EE having a red color, the color data selecting signal is a signal for outputting the repair driving current RID corresponding to the red color. For example, when the defective pixel includes the light emitting element EE having a green color, the color data selecting signal is a signal for outputting the repair driving current RID corresponding to the green color. For example, when the defective pixel includes the light emitting element EE having a blude color, the color data selecting signal is a signal for outputting the repair driving current RID corresponding to the blude color. However, the present disclosure is not limited to a color of the light emitting element EE exemplified above.

The data selecting block 220 may generate the location data selecting signal for activating either the first repair pixel block 110 or the second repair pixel block 120. For example, when the defective pixel is located close to the first side, the first repair pixel block 110 may be activated based on the location data selecting signal. For example, when the defective pixel is located close to the second side, the second repair pixel block 120 may be activated based on the location data selecting signal.

In an embodiment, the location data selecting signal may be a signal for activating some of the first repair pixels included in the first repair pixel block 110. In an embodiment, the location data selecting signal may be a signal for activating some of the second repair pixels included in the second repair pixel block 120.

In an embodiment, the data selecting block 220 may include a test register. The test register may store a test data. A panel characteristic of the display panel 100 may be tested through the test register. For example, the panel characteristic may include a luminance characteristic, a grayscale characteristic, a color-matrix characteristic, and etc. Accordingly, a driving reliability and a driving stability of the repair pixel RPX generating the repair driving current RID may be improved.

The offset calculating block 230 may output an offset signal OFFS based on the data selecting signal CS. The offset calculating block 230 may generate the offset signal OFFS based on the panel characteristic of the display panel 100 and the data selecting signal CS. For example, a plurality of reference grayscale voltages corresponding to a grayscale of the pixels PX may be calculated based on the panel characteristic. A reference grayscale signal corresponding to the reference grayscale voltages may be generated. For example, the reference grayscale voltages may include first to ninth reference voltages. In an embodiment, a reference grayscale look-up table may be generated by using the first to ninth reference voltages. For example, the reference grayscale look-up table may be generated by interpolating between the first to ninth reference voltages. However, the present inventive concept is not limited to the number of the reference voltages.

In an embodiment, different sets of the reference grayscale voltages may be calculated depending on a color of the light emitting element EE included in the pixels PX. And, a color reference grayscale signal corresponding to one color may be generated based on one set of the reference grayscale voltages corresponding to the one color. For example, red reference grayscale voltages corresponding to a red color may be calculated. A red reference grayscale signal may be generated based on the red reference grayscale voltages. For example, a green reference grayscale voltages corresponding to a green color may be calculated. A green reference grayscale signal may be generated based on the green reference grayscale voltages. For example, a blue reference grayscale voltages corresponding to a blue color may be calculated. A blue reference grayscale signal may be generated based on the blue reference grayscale voltages.

In an embodiment, the offset signal OFFS may be calculated by using Equation 1 below.

$$OFFS = CS + CRGS [ P ] + \{ ( \frac{CS - RGS [ P ]}{RGS [ P + 1 ] - RGS [ P ]} ) * CRGS [ P + 1 ] \} \qquad [ Equation 1 ]$$

Herein, the OFFS may represent the offset signal OFFS, the CS may represent the data selecting signal CS, the CRGS[P] may represent the color reference grayscale signal in a P-th frame (where P is a positive integer), the CRGS[P+1] may represent the color reference grayscale signal in a P+1-th frame, the RGS[P] may represent the reference grayscale signal in the P-th frame, and the RGS[P+1] may represent the reference grayscale signal in the P+1-th frame.

The offset signal OFFS may be calculated by using the Equation 1, so that an accuracy of the offset signal OFFS may be improved. Accordingly, a driving reliability and a driving stability of the repair pixel RPX which generates the repair driving current RID may be improved. Additionally, the emission reliability of the light emitting element EE included in the repair pixel RPX may be further improved.

The amplifier compensating data outputting block 240 may output an amplifier compensating data signal CDS based on the data selecting signal CS. The amplifier compensating data outputting block 240 may generate the amplifier compensating data signal CDS based on amplifier characteristics of the first repair amplifying block 520 and the second repair amplifying block 530. For example, the amplifier characteristic may include factors such as an amplifier's output current, an amplifier's offset voltage, and etc.

Generally, the amplifier characteristic may be different depending on a manufacturing process of the display apparatus. Accordingly, unless the amplifier characteristic is considered, a driving reliability and a driving stability of the defective pixel may decrease.

In an embodiment, the amplifier compensating data outputting block 240 may generate the amplifier compensating data signal CDS by considering the amplifier characteristic. Accordingly, the first repair data signal LCDATA reflecting the amplifier characteristic may be applied to the first repair amplifying block 520. Additionally, the second repair data signal RCDATA reflecting the amplifier characteristic may be applied to the second repair amplifying block 530. Accordingly, a driving reliability and a driving stability of the repair pixel RPX generating the repair driving current RID may be improved.

The delay calculating block 250 may output a delay data signal FCS based on the offset signal OFFS and the amplifier compensating data signal CDS. The delay calculating block 250 may generate the delay data signal FCS of FIG. 5 based on the offset signal OFFS, the amplifier compensating data signal CDS and a calculation delay. For example, the calculation delay may occur while the data selecting block 220 generates the data selecting signal CS. For example, the calculation delay may occur while the offset calculating block 230 generates the offset signal OFFS. For example, the calculation delay may occur while the amplifier compensating data outputting block 240 generates the amplifier compensating data signal CDS.

In an embodiment, the driving controller 200A may generate the data signal DATA based on the delay data signal FCS. The data signal DATA may include the first repair data signal LCDATA, the second repair data signal RCDATA and the pixel data signal PDATA

In an embodiment, the first repair driving current applied to the defective pixel may be generated based on the first repair data voltage LRVDTA. The first repair data voltage LRVDATA may be generated based on the first repair data signal LCDATA. Additionally, the panel characteristic, the amplifier characteristic and the calculation delay may be considered to generate the first repair data signal LCDATA. Accordingly, a driving reliability and a driving stability of the repair pixel generating the repair driving current RID may be improved. Additionally, an emission reliability of the light emitting element EE included in the defective pixel may be improved.

Additionally, the second repair driving current applied to the defective pixel may be generated based on the second repair data voltage RRVDTA. The second repair data voltage RRVDATA may be generated based on the second repair data signal RCDATA. Additionally, the panel characteristic, the amplifier characteristic and the calculation delay may be considered to generate the second repair data signal RCDATA. Accordingly, a driving reliability and a driving stability of the repair pixel generating the repair driving current RID may be improved. Additionally, an emission reliability of the light emitting element EE included in the defective pixel may be improved.

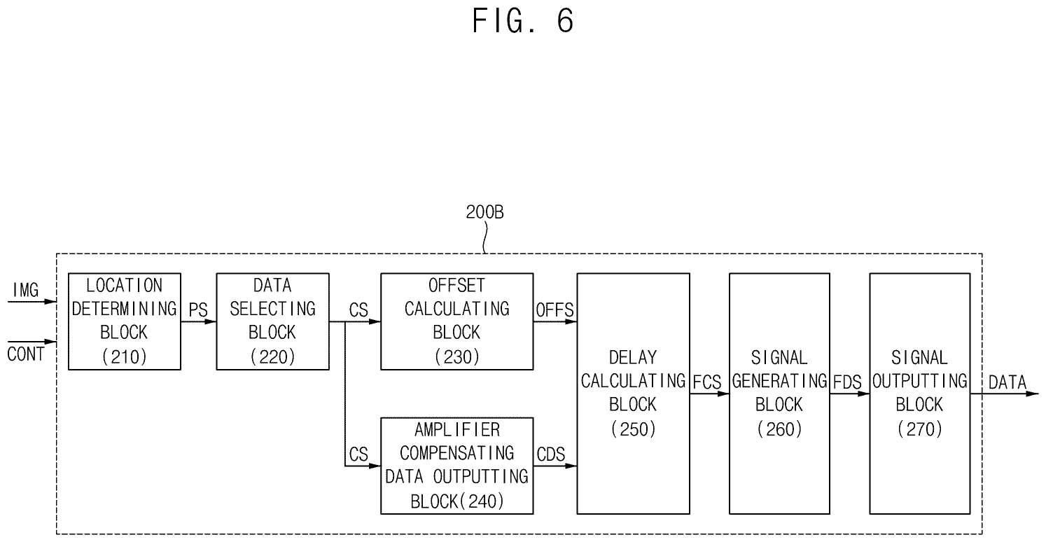

FIG. 6 is a block diagram illustrating a driving controller 200 included in a display apparatus of FIG. 1.

In an embodiment, a driving controller 200B is substantially same as the driving controller 200A as depicted in FIG. 5, except that the driving controller 200B further includes a signal generating block 260 and a signal outputting block 270. The same reference numerals are used for the same or similar components as described above, and redundant descriptions will be omitted.

Referring to FIG. 1 to FIG. 6, the driving controller 200B may include the location determining block 210, the data selecting block 220, the offset calculating block 230, the amplifier compensating data outputting block 240, the delay calculating block 250, the signal generating block 260 and the signal outputting block 270.

The signal generating block 260 may receive the delay data signal FCS from the delay calculating block 250. The signal generating block 260 may generate a final repair signal FDS based on the delay data signal FCS. The signal generating block 260 may output the final repair signal FDS. For example, the final repair signal FDS may be a binary code. In an embodiment, the final repair signal FDS may include a divided signal and a protocol signal. The signal generating block 260 may include a dividing block and a protocol generating block. The dividing block may output the divided signal that distributes the delay data signal FCS. The protocol generating block may generate and output the protocol signal based on the delay data signal FCS.

The signal outputting block 270 may receive the final repair signal FDS from the signal generating block 260. The signal outputting block 270 may output the data signal based on the final repair signal FDS.

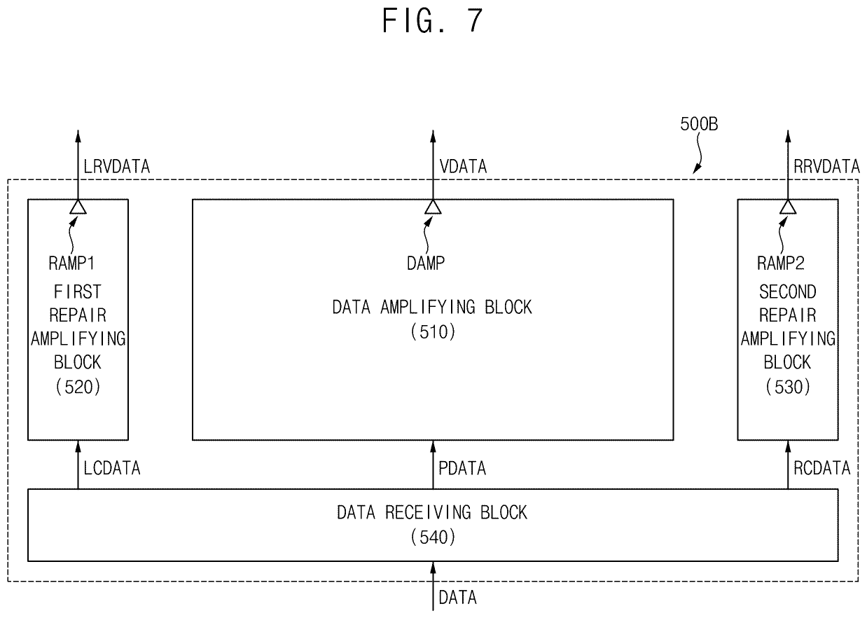

FIG. 7 is a block diagram illustrating a data driver 500 included in a display apparatus of FIG. 1.

In an embodiment, a data driver 500B is substantially same as the data driver 500A as depicted in FIG. 4, except that the data driver 500B further includes a data receiving block 540. The same reference numerals are used for the same or similar components as described above, and redundant descriptions will be omitted.

Referring to FIG. 1 to FIG. 7, the data receiving block 540 may receive the data signal from the signal outputting block 270.

The data receiving block 540 may output the pixel data signal PDATA to the data amplifying block 510. The data receiving block 540 may output the first repair data signal LCDATA to the first repair amplifying block 520. The data receiving block 540 may output the second repair data signal RCDATA to the second repair amplifying block 530.

In an embodiment, the first repair driving current applied to the defective pixel may be generated based on the first repair data voltage LRVDTA. The first repair data voltage LRVDATA may be generated based on the first repair data signal LCDATA. Additionally, the panel characteristic, the amplifier characteristic and the calculation delay may be considered to generate the first repair data signal LCDATA. Accordingly, a driving reliability and a driving stability of the repair pixel generating the repair driving current RID may be improved. Additionally, an emission reliability of the light emitting element EE included in the defective pixel may be improved.

Additionally, the second repair driving current applied to the defective pixel may be generated based on the second repair data voltage RRVDTA. The second repair data voltage RRVDATA may be generated based on the second repair data signal RCDATA. Additionally, the panel characteristic, the amplifier characteristic and the calculation delay may be considered to generate the second repair data signal RCDATA. Accordingly, a driving reliability and a driving stability of the repair pixel generating the repair driving current RID may be improved. Additionally, an emission reliability of the light emitting element EE included in the defective pixel may be improved.

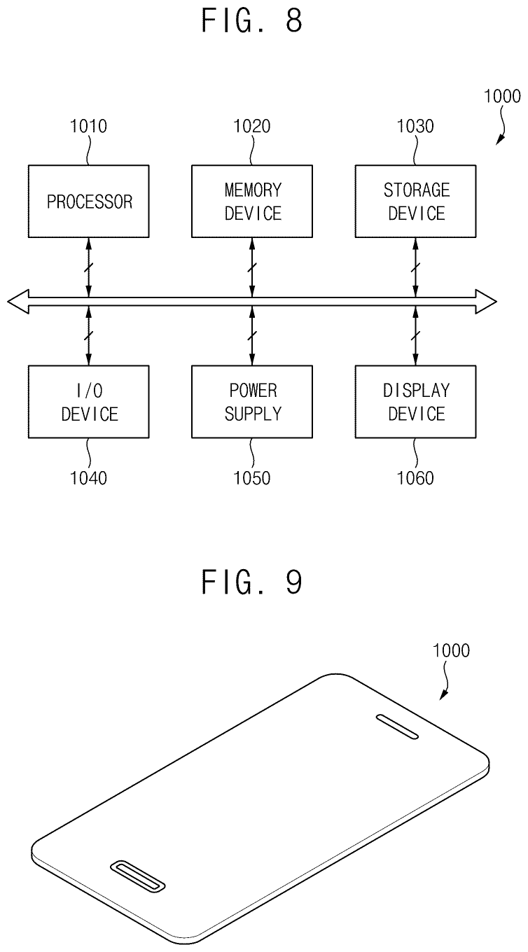

FIG. 8 is a block diagram illustrating an electronic device 1000 according to an embodiment of the present disclosure. FIG. 9 is a diagram illustrating an example in which an electronic device of FIG. 8 is implemented as a smart phone.

Referring to FIG. 8, the electronic device 1000 may include a processor 1010, a memory device 1020, a storage device 1030, an input/output (I/O) device 1040, a power supply 1050, and a display device 1060. Here, the display device 1060 may be the display apparatus of FIG. 1. In addition, the electronic device 1000 may further include a plurality of ports for communicating with a video card, a sound card, a memory card, a universal serial bus (USB) device, or other electronic device.

In an embodiment, as illustrated in FIG. 9, the electronic device 1000 may be implemented as a smart phone. However, the electronic device 1000 is not limited thereto. For example, the electronic device 1000 may be implemented as a cellular phone, a video phone, a smart pad, a smart watch, a tablet PC, a car navigation system, a computer monitor, a laptop, a head mounted display (HMD) device, and the like.

The processor 1010 may perform various computing functions or various tasks. The processor 1010 may be a micro-processor, a central processing unit (CPU), an application processor (AP), and the like. The processor 1010 may be coupled to other components via an address bus, a control bus, a data bus, etc. Further, the processor 1010 may be coupled to an extended bus such as a peripheral component interconnection (PCI) bus.

The processor 1010 may output the input image data IMG, the app-on signal APPON and the input control signal CONT to the driving controller 200 of FIG. 1.

The memory device 1020 may store data to operate the electronic device 1000. For example, the memory device 1020 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, and the like and/or at least one volatile memory device such as a dynamic random access memory (DRAM) device, a static random access memory (SRAM) device, a mobile DRAM device, and the like.

The storage device 1030 may include a solid state drive (SSD) device, a hard disk drive (HDD) device, a CD-ROM device, and the like. The I/O device 1040 may include an input device such as a keyboard, a keypad, a mouse device, a touch-pad, a touch-screen, and the like and an output device such as a printer, a speaker, and the like. In some embodiments, the display device 1060 may be included in the I/O device 1040. The power supply 1050 may provide power to operate the electronic device 1000. The display device 1060 may be coupled to other components via the buses or other communication links.

Referring to FIG. 9, the electronic device according to the present disclosure is implemented as a smartphone, but the present disclosure is not limited thereto. The electronic device may be a television, a monitor, a laptop computer, or a tablet. Additionally, the electronic device may be a car.

The display device according to an embodiment may be applied to a computer, a notebook, a mobile phone, a smart phone, a smart pad, a PMP, a PDA, an MP3 player, or the like.

The foregoing is illustrative of the present inventive concept and is not to be construed as limiting thereof. Although a few embodiments have been described, those skilled in the art will readily appreciate that many modifications are possible in the embodiments without materially departing from the novel teachings and advantages of the present disclosure. Accordingly, all such modifications are intended to be included within the scope of the present disclosure as defined in the claims. In the claims, means-plus-function clauses are intended to cover the structures described herein as performing the recited function and the equivalent thereof. Therefore, it is to be understood that the foregoing is illustrative of the present inventive concept and is not to be construed as limited to the specific embodiments disclosed herein, and that modifications to the disclosed embodiments, as well as other embodiments, are intended to be included within the scope of the appended claims. The present inventive concept is defined by the following claims, with equivalents of the claims to be included therein.

What is claimed is:

1. A display apparatus comprising:
a display panel including a first repair pixel block, a second repair pixel block and a plurality of pixels;
a gate driver configured to output a gate signal to the display panel;
a data driver configured to apply a data voltage based on a data signal to the display panel; and
a driving controller configured to control the gate driver and the data driver, and output the data signal based on input image data,
wherein either the first repair pixel block or the second repair pixel block applies a repair driving current to at least one pixel among the plurality of pixels based on the data signal and a location of the at least one pixel.

2. The display apparatus of claim 1, wherein the data driver includes:
a first repair amplifying block applying a first repair data voltage to the first repair pixel block;
a second repair amplifying block applying a second repair data voltage to the second repair pixel block; and
a data amplifying block applying a pixel data voltage to the pixels.

3. The display apparatus of claim 2, wherein the first repair pixel block generates a first repair driving current based on the first repair data voltage, and
wherein the second repair pixel block generates a second repair driving current based on the second repair data voltage.

4. The display apparatus of claim 1, wherein driving controller includes:
a location determining block determining the location of the at least one pixel and outputting a location signal, the at least one pixel receiving the repair driving current;
a data selecting block outputting a data selecting signal generated by determining a color of the at least one pixel and a repair pixel block connected close to the at least one pixel based on the location signal;
an offset calculating block outputting an offset signal based on the data selecting signal;
an amplifier compensating data outputting block outputting an amplifier compensating data signal based on the data selecting signal; and
a delay calculating block outputting a delay data signal based on the offset signal and the amplifier compensating data signal, and
wherein the data signal is generated based on the delay data signal.

5. The display apparatus of claim 4, wherein the location determining block generates the location signal by determining a pixel-row of the at least one pixel and a pixel-column of the at least one pixel.

6. The display apparatus of claim 4, wherein the data selecting signal includes a color data selecting signal, and
wherein the color data selecting signal is a signal for outputting the repair driving current corresponding to the color of the at least one pixel.

7. The display apparatus of claim 4, wherein the data selecting signal includes a location data selecting signal, and
wherein the location data selecting signal is a signal for activating one of the first repair pixel block and the second repair pixel block.

8. The display apparatus of claim 4, wherein the offset calculating block generates the offset signal based on the data selecting signal and a panel characteristic of the display panel.

9. The display apparatus of claim 8, wherein the offset signal is generated by using the data selecting signal and a reference grayscale look-up table based on the panel characteristic.

10. The display apparatus of claim 4, wherein the data driver includes a first repair amplifying block applying a first repair data voltage to the first repair pixel block and a second repair amplifying block applying a second repair data voltage to the second repair pixel block, and
wherein the amplifier compensating data outputting block generates the amplifier compensating data signal based on amplifier characteristic of the first repair amplifying block or the second repair amplifying block.

11. The display apparatus of claim 4, wherein the delay calculating block generates the delay data signal based on the offset signal, the amplifier compensating data signal, and a calculation delay occurring during an operation of at least one of the location determining block, the data selecting block, the offset calculating block and the amplifier compensating data outputting block.

12. The display apparatus of claim 4, wherein the data driver includes a data receiving block, and the driving controller further includes a signal outputting block,
wherein the signal outputting block outputs the data signal, and
wherein the data receiving block receives the data signal and outputs a first repair data signal to the first repair pixel block and a second repair data signal to the second repair pixel block.

13. The display apparatus of claim 1, wherein the first repair pixel block and the second repair pixel block are connected with each of the plurality of pixels through a repair line.

14. The display apparatus of claim 13, wherein the first repair pixel block includes a plurality of first repair pixels and the second repair pixel block includes a plurality of second repair pixels,
wherein the at least one pixel includes a light emitting element,
wherein a repair pixel among the plurality of first repair pixels or the plurality of second repair pixels is connected with and applies the repair driving current to the light emitting element through the repair line, and
wherein the light emitting element emits light based on the repair driving current.

15. The display apparatus of claim 13, wherein the display panel includes a gate line receiving the gate signal, a data line receiving the data voltage and the repair line, and
wherein the gate line and the repair line extend in a first direction, and the data line extends in a second direction different from the first direction.

16. The display apparatus of claim 1, the first repair pixel block is located in a first side of the display panel and the second repair pixel block is located in a second side of the display panel different from the first side of the display panel.

17. A driving controller comprising:
a location determining block determining a location of a defective pixel and outputting a location signal indicating the location of the defective pixel, the defective pixel receiving a repair driving current;
a data selecting block outputting a data selecting signal generated by determining a repair pixel block connected close to the defective pixel based on the location signal;
an offset calculating block outputting an offset signal based on the data selecting signal;
an amplifier compensating data outputting block outputting an amplifier compensating data signal based on the data selecting signal; and
a delay calculating block outputting a delay data signal based on the offset signal and the amplifier compensating data signal.

18. The display apparatus of claim 17, wherein the data selecting signal includes a color data selecting signal, and
wherein the color data selecting signal is a signal for outputting the repair driving current corresponding to a color of the defective pixel.

19. The display apparatus of claim 17, wherein the data selecting signal includes a location data selecting signal, and
wherein the location data selecting signal is a signal for activating one of the first repair pixel block and the second repair pixel block.

20. The display apparatus of claim 17, wherein the amplifier compensating data outputting block generates the amplifier compensating data signal based on amplifier characteristic of the first repair amplifying block or the second repair amplifying block.
